(19) United States
(12) Patent Application Publication
(10) Pub. No.: US 2005/0017507 A1
(43) Pub. Date: Jan. 27, 2005

(54) HVAC saddle tap fitting with rotatable collar

(76) Inventor: Gary A. Jensen, Napa, CA (US)

Correspondence Address: Donald Diamond, 2nd Floor, 2180 Jefferson Street, Napa, CA, 94559-1200, US

(21) Appl. No.: 10/623,265

(22) Filed: Jul. 21, 2003

(51) Int. Cl. F16L 25/00

(52) U.S. Cl. 285/197; 285/424

(57) ABSTRACT

A saddle tap fitting formed from sheet metal for attaching an HVAC branch line to a circular or flat-oval main trunk line. The fitting includes a cylindrical collar rotatably attached to a body having a skirt which flexibly conforms to the arcuate surface to which the body is attached. Rotating the collar smoothly changes the angle at which the collar is canted, within a range of about 55 to 90 degrees.

### BACKGROUND OF THE INVENTION

1. Field of the Invention

The present invention relates to ducting for heating, ventilating and air conditioning (HVAC) systems and, more particularly, to a sheet metal fitting for connecting a branch line by tapping into a main trunk line.

2. Description of the Related Art

Rectangular ducts remain widely used in HVAC installations because, compared to other shapes, a rectangular cross-section provides the greatest area, and therefore the greatest air flow rate capacity, for any maximum width or height dimension. Also, rectangular ducts and “fittings” (i.e., detachable parts for connecting duct section ends, or for tapping into a duct section of a relatively large cross-section to connect to a duct section of a relatively small cross-section) are relatively easy to fabricate, and the edges of the several pieces needed to form a section or fitting may be conveniently machine-formed to create a snap-lock or similar seam without resort to welding or another time-consuming process. However, rectangular ducts have significant shortcomings including the short lengths of the duct sections available and the relative complexity of manufacturing straight sections which conventionally are formed from coil sheet metal stock usually not more than five feet in width. While straight sections of virtually any length can, in principle, be made by rolling out sufficient stock, because of the coil width constraint only certain size ducts can be fabricated without substantial waste. Straight sections are fabricated not by uncoiling long lengths of sheet metal but by forming the requisite component pieces by a series of transverse cuts. There is little waste, but section length is limited to the width of the coil stock.

Use of duct sections with circular or “flat-oval” cross-sections avoid the length limitation of rectangular sections but introduce other problems. Circular duct is wound as a solid helix from a relatively narrow coil. The diameter of a finished section 10 is that of the helix and may be any reasonable size. A section of any length may be fabricated by continuing the helical winding process until the desired length is reached. Installed in a constrained space such as a duct race, circular duct has the least efficient flow rate. A circular duct must be as high as it is wide, so greater capacity cannot be achieved simply by making the duct wider. Even if a duct is sized to match the available height dimension, circular duct “fills” this full height only in the center, leaving unused dead spaces in what would be the corners of a rectangular (square) duct. In contrast, rectangular duct fills the full available height space across its entire width.

Flat-oval duct avoids the inefficiency of circular duct while maintaining its simplicity of construction and length versatility. One method for manufacturing flat-oval duct is to first wind a circular section and then “ovalize” it by placing it on a pair of mandrels which are sequentially forced outwardly, transverse to the longitudinal axis, to form an oval cross-section determined by four alternately linear and arcuate sides. Flat-oval duct approximates the flow rate of rectangular duct while not sacrificing the advantages of circular duct. However, fittings for flat-oval duct are considerably more difficult to manufacture than corresponding rectangular fittings. A typical flat-oval fitting is comprised of a plurality of “gore” sections, each of which must be formed into an oval contour from an irregularly-shaped cut-out. Because the edges of the gore sections are continuously curved, machine formation of seams is difficult and expensive.

An HVAC installation typically includes at least one main “trunk line” formed by relatively large cross-section duct sections, and a plurality of “branch lines” with relatively small cross-section duct sections tapped into a trunk line. “Saddle” taps are commonly used to attach a branch line duct to a trunk line which is circular, or to an arcuate surface of a trunk line which is flat-oval. Such a tap includes a saddle-shaped portion to which is attached at its convex side a short circular duct section which is either perpendicular to the saddle portion or canted at a fixed angle from the perpendicular, typically 45°. A hole is cut in a trunk duct section and the saddle portion is mounted over the hole and attached by stitch or spot welding. Alternatively, for a low pressure installation, rivets or metal screws may be used.

Saddle taps are also used in sewer systems which include a main pipe and tributary branch pipe which connect into the main pipe at locations along its length. U.S. Pat. No. 4,966,397 to R. M. McKinnon discloses a saddle device having a coupling portion made of a flexible elastomeric material which can be flexed to increase or decrease its curvature so as to fit any of a variety of main pipe sizes.

Saddle taps can also be used when laying copper conductor wires, coaxial cables and/or fiber optics cables, placed in a protective conduit or duct, in residential housing subdivisions and commercial buildings. U.S. Pat. No. 5,437,087 to G. Gordon discloses a method of attaching an “interduct” to a large circular or oval duct using a device having a saddle portion. The saddle has a radius substantially the same as the radius of the duct such that the saddle is slidably fittable against the duct and grips the duct.

Despite the wide usage of saddle taps in the HVAC industry, the only taps presently available commercially have a saddle which will accommodate only one trunk line size and shape and provide a fixed connector angle. Consequently, installers of relatively complex HVAC systems often must obtain taps in a wide variety of sizes and connector angles. Installation could be simplified and cost savings realized by providing a standard saddle tap which could accommodate a range of circular and flat-oval trunk line sizes, and a range of connector angles.

### OBJECTS OF THE INVENTION

In view of the foregoing considerations, it is an object of the present invention to provide a saddle tap fitting which is adaptable to a range of circular and flat-oval trunk line sizes, and which provides a range of connector angles.

Another object of the invention is to provide a saddle tap which is simple to manufacture and reliable once installed.

Still another object of the invention is to provide a saddle tap allowing reduction of expensive inventory.

Yet another object of the invention is to provide a saddle tap configuration where taps differing in size can be nested to save shipping and packaging costs.

Other objects of the invention will become evident when the following description is considered with the accompanying drawings.

### SUMMARY OF THE INVENTION

These and other objects are met by the present invention which in a first aspect provides a fitting for attaching an end of a duct section of relatively small cross-section to an arcuate surface of a duct section of relatively large cross-section. The fitting includes a cylindrical collar having a circular first end orthogonal to the collar axis, and a circular second end at an oblique angle to the axis. The fitting further includes a body having an upper portion terminating in a circular end inclined at the same angle. The collar second end is rotatably attached to the body upper portion end.

In a second aspect the invention provides a fitting for attaching an end of a duct section of relatively small cross-section to an arcuate surface of a duct section of relatively large cross-section. The fitting includes a cylindrical collar having a circular first end orthogonal to the collar axis, and a circular second end oblique to the axis. The fitting further includes a body having an upper portion terminating in a circular end inclined at the same angle, and means for rotatably attaching the collar second end to the body upper portion end which includes an arc-shaped bead circumscribing the collar second end which is interlocked with an arc-shaped bead circumscribing the body upper portion end.

These and other features and advantages of the invention will become further apparent from the detailed description that follows, which is accompanied by drawing figures. In the figures and description, numerals indicate the various features of the invention, like numerals referring to like features throughout both the drawings and description.

### BRIEF DESCRIPTION OF THE DRAWINGS

FIG. 1 is an exploded perspective view of a saddle tap fitting according to the invention including a body having a skirt portion with first and second flanges, a collar rotatable relative to the body, and a damper positioned within the collar.

FIG. 2 is a forward perspective view of the FIG. 1 fitting.

FIG. 2A is a cross-sectional view taken through lines 2A-2A in FIG. 2 showing how the collar is rotatably attached to the body.

FIG. 2B is a detail view of region “2B” in FIG. 2, indicating that each attachment tab is bounded by notches where the tab is joined to a forward or rearward edge.

FIG. 3 is a bottom plan view of the FIG. 1 fitting.

FIG. 4 shows the FIG. 1 fitting tapped into a HVAC main trunk line duct section with the collar oriented relative to the body such that the collar is generally orthogonal relative to the duct section.

FIG. 5 shows the FIG. 4 fitting with the collar rotated 180° from the FIG. 4 orientation so that the collar is canted at a maximum possible inclination relative to the duct section.

FIG. 6 schematically shows two FIG. 1 fittings tapped into a main trunk line duct section with each connected to a branch line duct section.

### DESCRIPTION OF THE PREFERRED EMBODIMENT

While the present invention is open to various modifications and alternative constructions, the preferred embodiment shown in the drawings will be described herein in detail. It is to be understood, however, there is no intention to limit the invention to the particular form disclosed. On the contrary, it is intended that the invention cover all modifications, equivalences and alternative constructions falling within the spirit and scope of the invention as expressed in the appended claims.

Where used herein, the word “attached” means that the two parts referred to (e.g., the body and collar) are joined in a permanent combination. Where used herein, the word “connected” means that the two parts referred to (e.g., a duct section end inserted into the collar) are not permanently joined.

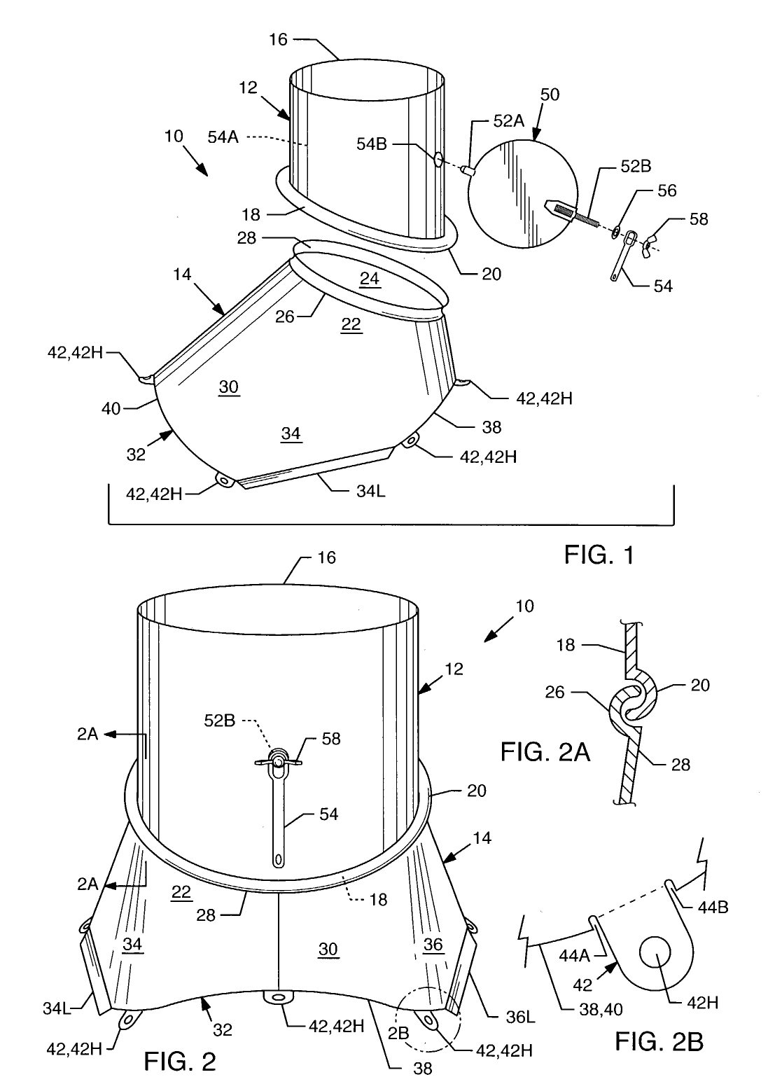

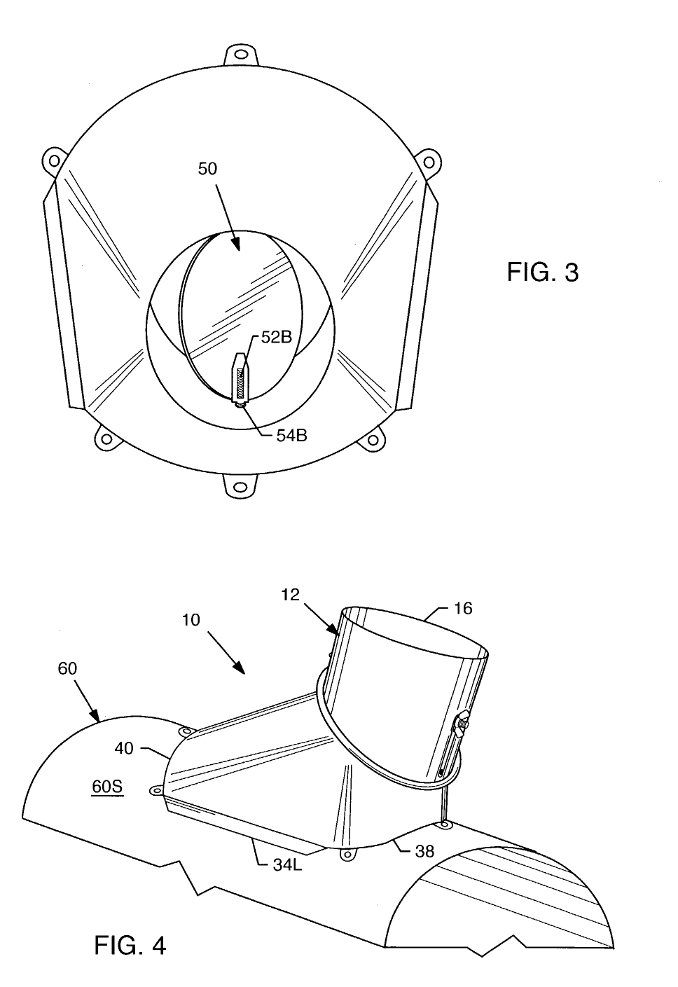

Referring to FIGS. 1 and 2, a saddle tap fitting 10 according to a preferred embodiment of the invention includes a generally cylindrical collar 12 rotatably attached to a body 14. Collar 12 has a first generally circular end 16 generally orthogonal to the collar axis, and a second generally circular end 18 oblique to the axis at a predetermined angle. End 18 has an arc-shaped bead 20 around its circumference. Body 14 includes an upper portion 22 terminating in a generally circular aperture 24 sloping at the same angle as collar end 18 and having an arc-shaped bead 26 around the circumference of a generally circular end 28. As shown in FIG. 2A, ends 18 and 28 smoothly interface and beads 20 and 26 interlock so that collar 12 rotates when body 14 is maintained stationary and a torque is applied to the collar. Body 14 flares downwardly in a cone-shaped skirt 30 terminating in a base 32, and having generally opposed first and second flanges 34, 36 terminating, respectively, in canted lips 34L, 36L. Base 32 is determined circumferentially by lips 34L, 36L and arch-shaped forward and rearward edges 38, 40, respectively, disposed between lips 34L, 36L. Edge 38 is arched higher than edge 40 so that fitting 10 is pitched forwardly when attached to a duct section. The shape of skirt 30 provides flexibility needed to fit a range of duct section sizes and arcuately-shaped surfaces. Base 32 includes a plurality of attachment tabs 42, with holes 42H therethrough, bent out at an angle matching the contour of a main trunk line surface so that fitting 10 can be tightly attached by means such as rivets or screws. The holes facilitate stressing of skirt 30 to match the contour. As indicated in FIG. 2B, notches 44A, 44B in edge 38 or 40 bound each tab 42 so that the tab when bent outwardly at dotted line 45 will not protrude beneath the skirt 30, thereby providing a tighter fit.

Referring to FIGS. 1, 2 and 3, optionally, a damper 50 is pivotally positioned within collar 12 and connected to the collar by opposed first and second pivot portions 52A, 52B attached to damper 50 and passing, respectively, through diametrically opposed holes 54A, 54B in the collar. Portion 52B, which is threaded, receives a lever 54 secured between a washer 56, and a wing-nut 58 threaded onto portion 52B. Lever 54 is used to adjust the inclination of the damper 50 as to increase or decrease air flow rate.

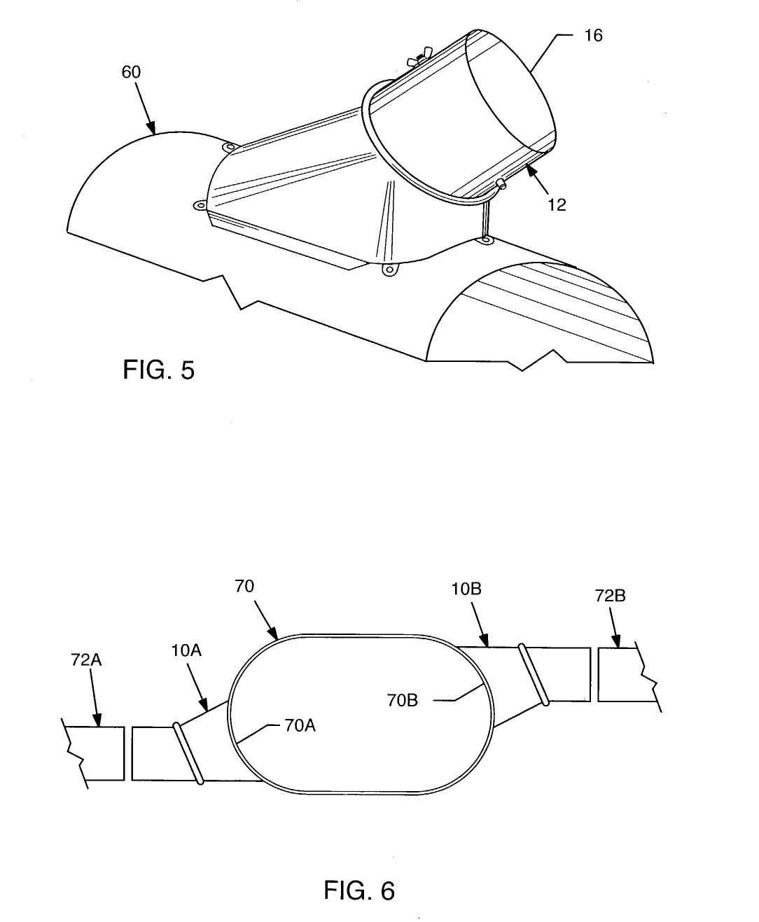

FIG. 4 shows the fitting 10 attached to a surface 60S of a duct section 60 of a circular or flat-oval trunk line and positioned over a hole cut into the duct section which is larger than the cross-sectional area of collar 12 but smaller than the area determined by the perimeter formed by lips 34L, 36L and edges 38, 40. Collar 12 is oriented with respect to body 14 at a first position such that the collar end 16 is generally orthogonal to a plane tangent to surface 60S at a point coinciding with the longitudinal axis of collar 12. FIG. 5 shows the collar 12 rotated 180° with respect to body 14 to a second position so that collar end 16, and therefore collar 12, are maximally canted at about 35° with respect to the longitudinal axis, i.e., canted about 55° with respect to duct section 60. As the collar 12 is rotated clockwise or counterclockwise between the first and second positions, the angle at which the collar is canted with respect to the longitudinal axis smoothly changes from a minimum of about 0° to a maximum of about 35°. Thus, the angle at which the collar is canted with respect to the duct section 60 changes from a maximum of about 90° to a minimum of about 55°. For a fixed orientation of damper 50, or when the damper is absent, maximum air flow occurs when the collar is canted at the minimum 55° angle.

Preferably, collar 12 and body 14 are made from patterns cut from sheet metal about 0.050-inch in thickness which are formed into the desired shapes and their ends riveted or welded together.

FIG. 6 schematically shows two saddle tap fittings 10A, 10B, attached, respectively, to arcuate portions 70A, 70B of a flat-oval main line duct section 70 and which connect, respectively, the main line to duct sections 72A, 72B of two branch lines.

1. A fitting for attaching an end of a duct section of relatively small cross-section to an arcuate surface of a duct section of relatively large cross-section, comprising:
a generally cylindrical collar having a generally circular first end generally orthogonal to the collar axis, and a generally circular second end oblique to said axis at a predetermined angle; and
a body having an upper portion terminating in a generally circular end inclined at said angle, said collar second end circumferentially attached to said body upper portion end thereby determining an interface plane, the collar second end rotatable in said plane with respect to the body upper portion end.

2. The fitting of claim 1, further comprising a skirt flaring downwardly from said body upper portion and terminating in a base, said skirt having generally opposed first and second flanges terminating, respectively, in canted first and second lips, said base determined circumferentially by said lips and arch-shaped forward and rearward edges disposed between the lips.

3. The fitting of claim 2, wherein a damper is pivotally positioned within the collar.

4. The fitting of claim 2, wherein said forward edge is arched higher than said rearward edge.

5. The fitting of claim 4, wherein when said skirt base is attached to an arcuate surface of a relatively large cross-section duct section, said collar second end is rotatable so that the collar can be canted at any angle with respect to said duct section in a range from about 55 to about 90 degrees.

6. The fitting of claim 5, wherein said collar and body are each formed from sheet metal having a preselected thickness.

7. The fitting of claim 6, wherein said thickness is about 0.050-inch.

8-9. (canceled)

10. A fitting for attaching an end of a duct section of relatively small cross-section to an arcuate surface of a duct section of relatively large cross-section, comprising:
a generally cylindrical collar having a generally circular first end generally orthogonal to the collar axis, and a generally circular second end oblique to said axis at a predetermined angle and having a first circumferential arc-shaped bead;
a body having an upper portion terminating in a generally circular end inclined at said angle and having a second circumferential arc-shaped bead, said collar second end circumferentially attached to said body upper portion end by said first bead interlocked with said second bead, thereby determining an interface plane, the collar second end rotatable in said plane with respect to the body upper portion end; and
the body flaring downwardly in a cone-shaped skirt terminating in a base and having generally opposed first and second flanges terminating, respectively, in first and second canted lips, said base determined circumferentially by said lips, and first and second arch-shaped forward and rearward edges disposed between said lips.
